(19) United States
(12) Patent Application Publication
(10) Pub. No.: US 2003/0140218 A1
(43) Pub. Date: Jul. 24, 2003

(54) General purpose state machine

(75) Inventor: Howard G. Sachs, Los Altos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Teleraty Systems, Inc., Sunnyvale, CA (US)

(21) Appl. No.: 10/056,326

(22) Filed: Jan. 23, 2002

(51) Int. Cl. G06F 9/00

(52) U.S. Cl. 712/245

(57) ABSTRACT

A general purpose state machine employs generic components such as flags, counters, and programmable logic, enabling it to be easily reused, even if maintained in hard form. Preferably, the state machine is connected to receive information from an external circuit, typically a system to be controlled by the state machine. The state machine includes a programmable memory in which each row stores a word representing output information as a sequence of bits. The state machine includes a first multiplexer which has some of its input terminals coupled to receive the information from the external circuit, and some input terminals connected to receive information from the programmable memory. In response to these signals the first multiplexer provides an output signal. A control circuit is connected to receive the output signals from the first multiplexer. The control circuit provides a signal which selects a word in the programmable memory. The addressed word then causes the state machine to change to the next state, thereby controlling the external circuit.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

This invention relates to state machines, and in particular to a general purpose state machine which can be optimized for particular applications and is implemented as a portion of an integrated circuit.

A state machine, also known as a finite state machine, responds to events by moving from state to state according to a formal set of rules. These rules are typically customized for the particular problem to be solved. For example, state machines can be used in systems that control products such as home appliances or industrial products. The state machine typically includes three components: (1) a set of states, (2) a set of events, and (3) a mapping from each state or event to a corresponding action. This set of states requires that in any given time the machine be in a single state. The events are then actions which the machine recognizes. Typically, an event will represent an external input. The state machine, however, may also generate events internally which cause changes of state. Finally, the mapping from each state to a corresponding action means that the action may cause a transition to a different state, provide a particular output signal, or otherwise indicate transition to the successor state.

State machines are typically represented by diagrams in which each state is represented by a numbered circle. Arrows from one circle to another represent the possible transitions, with each arrow being labeled with the event that causes that particular transition. Computation by the state machine begins in the start state, but then the state machine will change to a new state caused by external signals provided to the state machine or an internal transition. There are many variants of state machines, for example, state machines can have actions or provide outputs which are based on transitions (Mealy machine) or based upon states (Moore machine). A state machine can be considered to be an abstract model of a system, for example, a physical, biological, mechanical, electronic, or software system.

A state machine can be used to model interaction between a system and its environment. Its state is a way of remembering what has occurred so far. A transition occurs when an event in the environment causes the system to change state. Given a sequence of inputs, a state machine will produce a sequence of outputs that is dependent upon the initial state, the transition functions which maps each current state and input to a next state, and an output function that maps each current state to an output. In Moore machines the output is a function of only the current state, while in Mealy machines the output is a function of the current state and the input.

It has been common in integrated circuit technology since the 1980's for distributed state machines to be used rather than a central control engine. This has resulted primarily because of the availability of the integrated circuit technology and increasing performance requirements. By distributing state machines across a chip with appropriate control points in appropriate locations, shorter electrical connections for critical paths results, improving performance.

In most integrated circuit designs today, state machines are designed using an RTL or a behavioral description. Each time that a new state transition is to be added to the state machine, for example, because of a change in the system being controlled by the state machine, the design is reimplemented and resynthesized. This takes unnecessary time, and results in designs in which neither power, nor performance, is optimized for the particular application. Of course, there is also the risk of design errors being introduced by the changes. Unfortunately, because of their non-optimized layout, the designs synthesized in this manner are usually slow and occupy large areas of the chip.

What is needed is a more general purpose state machine which can be optimized for particular applications, for example, in reduction of area of the resulting integrated circuit, power consumption, or some combination of factors. Such a general purpose state machine should be able to be implemented in software, firmware or hardware form.

### BRIEF SUMMARY OF THE INVENTION

This need in the prior art is addressed by implementation of a general purpose state machine readily useful for many different integrated circuit based systems. The state machine provided employs general purpose components such as flags, counters, and programmable logic, enabling it to be easily reused, even if maintained in hard form. In a preferred embodiment the general purpose state machine includes external input terminals, which receive information from an external circuit, typically a system to be controlled by the state machine. The state machine also includes a first multiplexer or group of multiplexers which has at least some of its input terminals coupled to receive the information from the external circuit, and to provide an output signal. The output signal from the first multiplexer or group of multiplexers is provided to a control circuit which typically includes a second multiplexer.

The system also includes a programmable memory, for example a ROM, PROM, SRAM, DRAM, or other memory, which has a plurality of rows. Each row stores a word (sequence of bits), and a word in the programmable memory is supplied to the output terminals of the memory in response to an address signal selecting that that word (row). Some bits from the output signal are used for control of the state machine, while other bits are provided to the external circuit.

The control circuit is connected to receive the output signal from the first multiplexer and connected to receive at least one sets of bits from the programmable memory, each set representing an address of another word in the memory. In response to the signals from the multiplexer, the control circuit provides a signal which selects one of the words in the programmable memory. The word selected corresponds to the address provided by some of the bits in the addressed word (or other signals indicative of a request that the state not change). Other bits from the selected word are then provided on various output lines to control the external circuit and control the state machine.

In general, the sizes of the multiplexers, sizes of the programmable memory, and other associated circuitry will be optimized for the particular application within which the state machine is employed. The state machine itself may be maintained in a “soft” or “hard” form. Examples of soft form are RTL and some HDL formats in which no physical information about the layout is maintained. In contrast, in hard form the state machine is maintained as a collection of polygons representing the shapes of regions for an integrated circuit. In soft form the particular state machine may be optimized for area, speed, power consumption, or other desired variables. In hard form the layout can be manually optimized for reuse in the same or similar technologies.

The invention provides numerous advantages over prior art state machines. Because the design is generally optimized to that required by a specific application, it is faster than previous state machines. It is also more flexible because it allows any number of external inputs, either by expanding the size of the first multiplexer, or supplying such additional inputs to programmable logic or other pre-state machine logic. The state machine also provides the ability to perform branch operations. It can change state without relying on hardwired logic. Further description of the advantages and structure of the state machine of this invention is found below.

### BRIEF DESCRIPTION OF THE DRAWINGS

FIG. 1 is a simplified block diagram of a general purpose state machine according to a preferred embodiment;

FIG. 2 is a more detailed block diagram;

FIG. 3 illustrates branch conditions and address selection by the system of FIG. 2;

FIG. 4 illustrates details of the counter of FIG. 2;

FIG. 5 is a diagram illustrating the programmable logic of FIG. 2; and

FIG. 6 illustrates details of the flags.

### DETAILED DESCRIPTION OF THE PREFERRED EMBODIMENTS

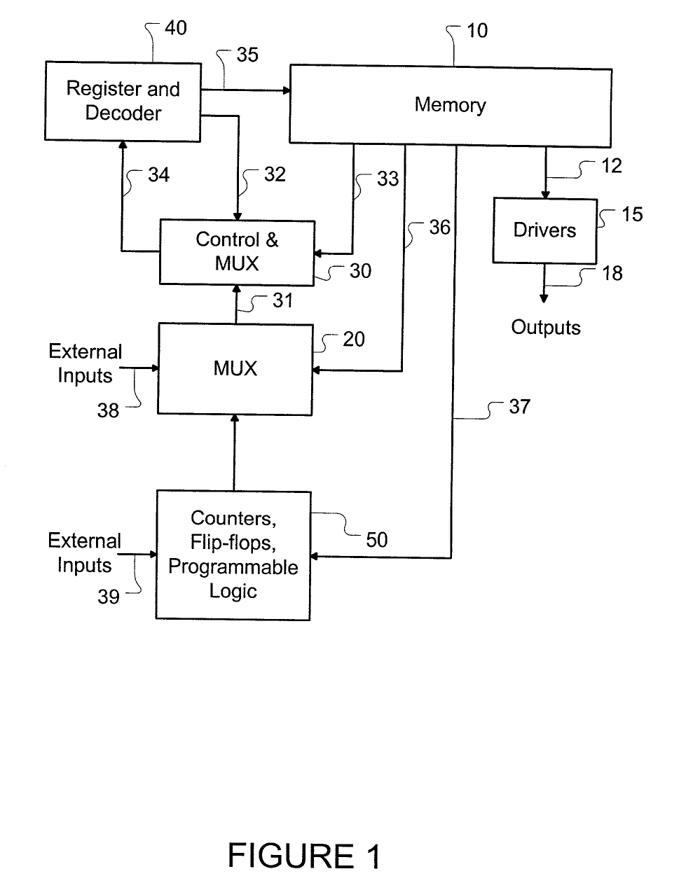

FIG. 1 is a block diagram of the general purpose state machine as implemented according to a preferred embodiment of this invention. As will be described below, the embodiment depicted enables a five-bit state machine, that is, one with thirty-two states. Of course, greater or lesser numbers of states may be implemented by making appropriate changes in the depicted components. On the other hand, because one of the advantages of the state machine described herein is its ability to function in many different environments, once the hardware layout is optimized for power consumption, speed, or other variable, use of less than all of the circuitry depicted may be advantageous, in contrast generating a new layout for the integrated circuit.

FIG. 1 is a simplified block diagram of the overall architecture of the state machine of the preferred embodiment. The basic components depicted there will be described generally, as to their function, and then more details provided as to the implementation. Particularly important components for an understanding of FIG. 1 are memory 10, a first multiplexer 20 and a control circuit 30. These will be explained first, followed by a discussion of the remaining components depicted.

Memory 10 is a programmable memory which may be volatile or nonvolatile. In the depicted embodiment, memory 10 is a ROM programmable by a mask during the semiconductor fabrication process used to manufacture the circuit shown in FIG. 1. In one embodiment the ROM consists of 32 rows (words) of information, with each row having 48 columns (bits), to thereby provide storage for 32 48-bit words. Each row in the memory corresponds to a state in the state machine. The particular state selected, that is, the particular word addressed, is controlled by control and multiplexer circuit 30 in response to signals received on line 31. The signal on line 31 will cause control circuit 30 to select one of the two inputs 32 or 33 and provide the information from the selected input to the register/decoder 40 as an address over line 34. (As described below, input terminals 33 may provide more than one address.) In the example depicted in FIG. 1, selection of input 32 results in one address being provided via register/decoder 40 to ROM 10, while selection of line 33 results in a different address being provided via control circuit 30, decoder 40, and line 35 to ROM 10. The received address is provided to ROM 10 via register/decoder 40. While the discussion above used the term “row” to describe the “state” of the state machine, the memory may be organized in any desired manner so portions of the memory other than rows may represent the “state” of the state machine.

In response to the address, the register/decoder selects one of the rows of ROM 10. For the example depicted, assume control circuit 30 placed the address “row 25” on input line 34, then register/decoder 40 will cause the next address provided to ROM 10 to be row (word) 25. In other words, the input signal on line 31 to control circuit 30 will cause the ROM 10 to change states from the state represented by the previously addressed row to the state represented by the word stored in row 25. This change in state will result in new output data being provided on line 12, as well as on lines 33, 36 and 37. Typically, the output signals will be provided to drivers 15 for supply either in pulse form or latched form to various external circuitry coupled to the drivers 15 by lines 18.

As mentioned, the output signal on line 34 from control circuit 30 provides the next address for the state machine. Control circuit 30 itself is controlled by multiplexer 20, and by counters, flip-flops and programmable logic circuitry 50. The mux and control circuit 20 receives external input signals 38, signals from circuitry 50, and internal control signals from memory 10 over lines 36. Similarly, circuitry 50 receives external input signals 39 and internal input signals from memory 10 over lines 37. The combination of all of the external and internal input signals to mux 20 and circuitry 50 determine the selection signal on line 31.

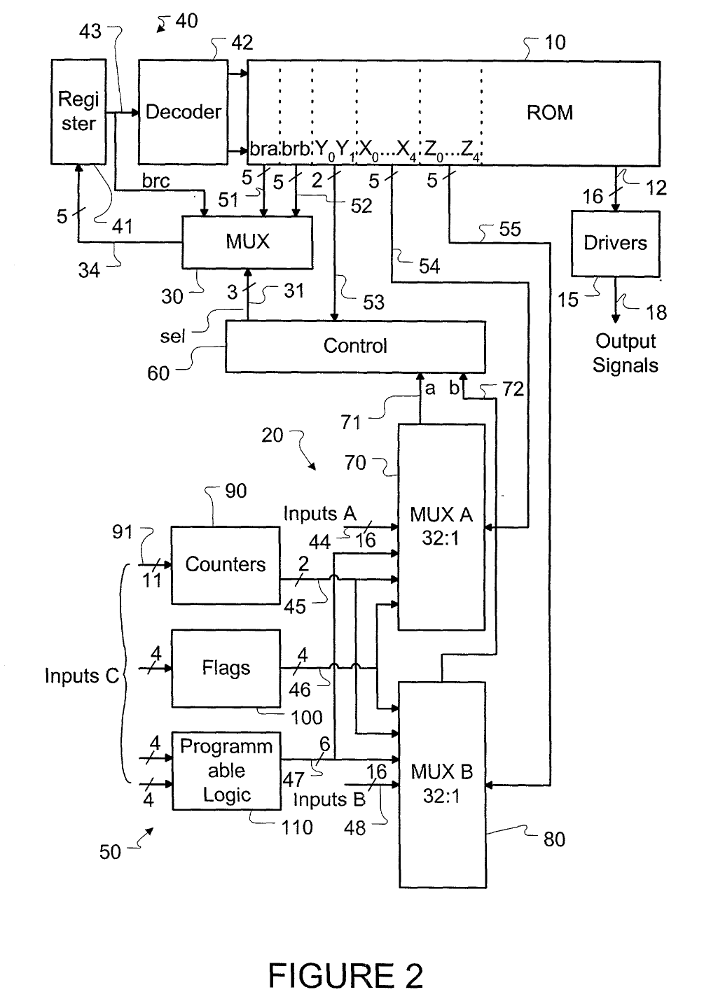

FIG. 2 is a more detailed block diagram illustrating one implementation of the conceptual level diagram of FIG. 1. Components in FIG. 2 have been given numerical designations to reflect corresponding components in FIG. 1. In FIG. 2, the register/decoder 40 is shown in more detail to consist of register 41 and decoder 42 coupled to each other by interconnection 43. As shown by the diagram, interconnection 43 is a five-bit signal provided from register 41 to decoder 42. The corresponding “width” of other interconnections shown in FIG. 2 is designated in the same manner throughout the diagram. Of course, more or fewer bits may be provided among the various interconnections, and serial connections can be employed in place of the parallel connections depicted.

Decoder 42 is coupled to ROM 10 with 32 address lines designated 0 to 31 in the diagram. The five-bit address signal supplied on line 43 to decoder 42 results in the selection of one of lines 0 to 31. The 48 bits of the selected word are then applied to the 48 output lines from the ROM 10. These 48 output lines include a five-bit signal branch a “bra” on lines 51 and a five-bit signal branch b “brb” on lines 52. Signal branch c “brc” indicative of remaining in the previous state is also supplied to mux 30 on line 32. As explained in conjunction with FIG. 1, the three control wires 31 will cause multiplexer 30 to select among input signals 32, 51 and 52. ROM 10 also provides a two-bit signal Y on lines 53 to control circuit 60. As will be discussed this signal enables different branching operations. In addition, five-bit signals X and Z are provided on lines 54 and 55, respectively, to partially control multiplexer A 70 and multiplexer B 80. This control is discussed further below.

The particular manner in which control circuit 60 provides the output signals on line 31 to control mux 30 is discussed next. Muxes 70 and 80 are coupled to receive external input signals A and B directly and external input signals C applied to counters 90, flags 100, and programmable logic 110. In addition, mux 70 receives the X input signals from ROM 10, while mux 80 receives the Z input signals from ROM 10. Thus, muxes 70 and 80 are controlled by “internal” signals from ROM 10, to select desired ones of the external signals. Of course other, or additional, signals from other types of input logic such as filters, memories, converters, etc. can also be provided to muxes 70 and 80.

The combination of external and internal input signals to mux 70 causes it to provide an output signal “a” on line 71. Similarly, the combination of external and internal input signals to mux 80 cause it to provide an output signal “b” on line 72. In a manner described further below, the combination of signals a and b on lines 71 and 72, together with signal Y on line 53, causes control circuit 60 to produce an appropriate output signal on lines 31. This output signal causes mux 30 to select among its various input signals 32, 51, and 52 and supply it over lines 34 to register 41, one of these addresses. This results in the selection of a particular word within ROM 10 on the next clock signal.

The particular manner in which mux 70 and 80 provide the output signals on lines 71 and 72 is discussed next. As depicted, each of muxes 70 and 80 is coupled to receive external signals which arrive on lines 45, 46, 47, 44 (mux A only), and 48 (mux B only). In the example of FIG. 2, there are 16 lines designated by reference numerals 44 and 48, two lines by reference numeral 45, four lines designated by reference numeral 46, and six lines designated by reference numeral 47. Of course, it will be appreciated that more or fewer lines may be employed. In addition to receiving these external signals, muxes 70 and 80 also receive “internal” select signals over lines 54 and 55. The internal select signals arriving at the muxes 70 and 80 over lines 54 and 55 are control signals supplied directly from ROM 10.

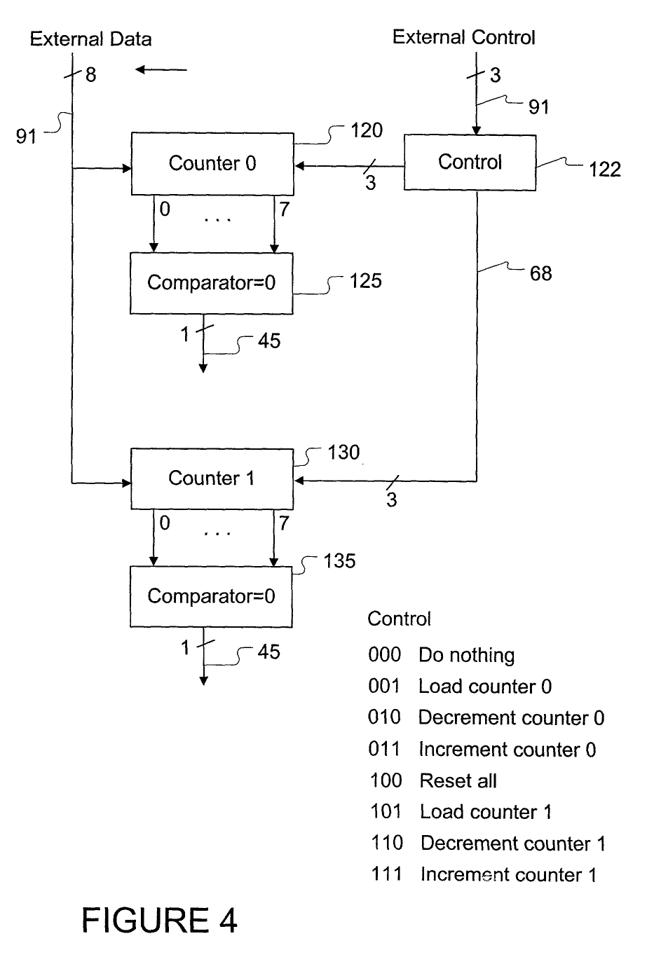

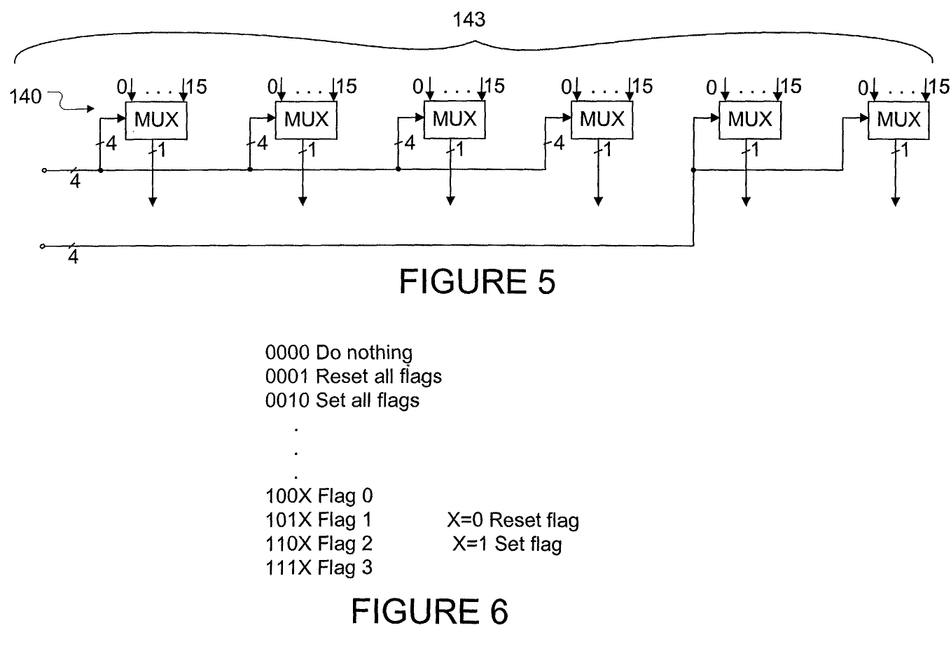

The input signals on lines 45 originate from counters 90. The initial count values and control information are provided over lines 91. These are discussed in FIG. 4. The programmable logic provides signals on lines 47, and is discussed in conjunction with FIG. 5. The input signals to muxes 70 and 80 arriving on lines 46 originate from flag circuits 100. The flag circuits are discussed in FIG. 6. The result of all of the external input signals and the internal input signals causes control circuit 60 to provide an output signal on line 31 which selects one of the three addresses on lines 32, 51 and 52 provided to mux 30.

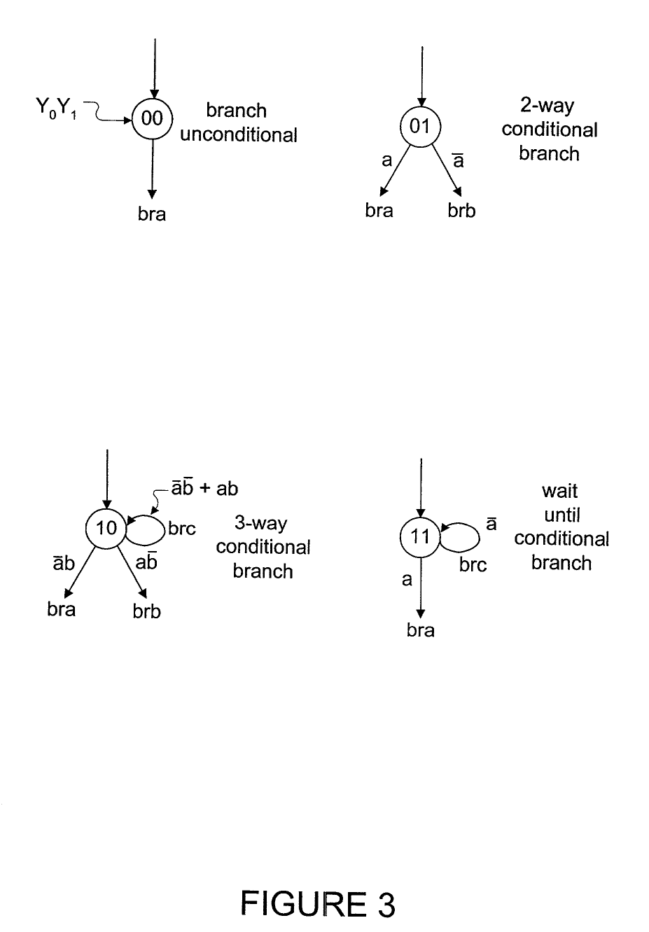

The flexibility of the general purpose state machine described herein can be better understood with reference to FIG. 3. FIG. 3 illustrates the branch conditions implemented by the system illustrated in FIG. 2. In FIG. 3 there are four different branch operations provided by the general purpose state machine, and the choice of the particular branch operation is determined by the Y₀ and Y₁ bits stored in ROM 10. A branch unconditional operation as shown in the upper left portion of FIG. 3. If each of Y₀ and Y₁ are 0, an unconditional branch operation is performed to select address bra.

In the upper right portion of FIG. 3, a two-way conditional branch operation is illustrated. This operation occurs when Y₀ is 0 and Y₁ is 1. In this circumstance the a output of multiplexer 70 (FIG. 2) will cause control circuit 60 to supply a signal on line 31 to mux 30 which selects either branch a (line 51), and therefore next address bra, or branch b (line 52) and therefore address brb.

The lower left corner of FIG. 3 illustrates a three-way condition branch operation in which one of address bra, address brb, or address brc (return to the same state) is selected. In this circumstance the output signal a on line 71 from mux 70 and the output signal b on line 72 from mux 80 are both used.

Finally, in the lower right portion of FIG. 3 a wait until conditional branch is depicted. There, as shown, if Y₀ and Y₁ are each 1, the state machine shifts to address bra or address brc, depending upon the a signal on line 71.

Thus, in summary, the state machine provides state control in the manner of enabling unconditional branches, conditional branches either two ways or three ways, and branches under control of the counters, flags or external inputs. The machine also enables the state machine to change states upon receipt of an external input.

The structure depicted in FIGS. 1 and 2 enables a state machine with 32 states, with additional states being provided if a larger ROM is employed in place of the 32-word ROM 10 depicted. As discussed, the choice of states is determined by all of the external and internal inputs. In particular, the output of the state machine is determined as follows, where a and b are the signals on lines 71 and 72, and Y₀ Y₁ are the signals on lines 53:

| Y₀Y₁ | Select bra | Select brb | Select brc |
|---|---|---|---|
| 00 | 1 | — | — |
| 01 | a | \overline{a} | — |
| 10 | \overline{a}b | a\overline{b} | \overline{a}\overline{b} + ab |
| 11 | a | — | \overline{a} |

Of course, other codes can be used in place of those described above.

Some states for the state machine can be selected in multiple ways. The equations below illustrate the different conditions that can be used to select a particular word. For example, as shown in the first equation, the select input on line 31 will choose the address bra in each of three conditions, that is, if Y₀ and Y₁ are 0, or if Y₁ is 1 and input a is 1, or if Y₀ is 1, Y₁ is 0, input a is 0 and input b is 1. The remainder of the equations can be similarly understood.

select bra=\overline{Y}₀\overline{Y}₁+Y₁a+Y₀\overline{Y}₁\overline{a}b

select brb=\overline{Y}₀Y₁\overline{a}+Y₀\overline{Y}₁a\overline{b}

select brc=Y₀\overline{Y}₁(\overline{a}\overline{b}+ab)+Y₀Y₁\overline{a}

FIG. 4 is a more detailed diagram of counter 90 shown in block form in FIG. 2. The combination of the circuitry shown in FIG. 4 forms counters 90. As shown in FIG. 4, a counter 120 is coupled to receive eight bits of data C over lines 91. This data includes three bits of control information provided to control circuit 122. As shown by the lower right-hand corner of FIG. 4, the control information received on lines 91 to control circuit 122 will cause the eight bits of data provided to counter 120 to cause no change by the counters 120 (if the control bits are 000). If the control bits are 001, then counter 120 will be loaded with the bits received on lines 91. A control circuit output of 010 will cause the counter 120 to begin decrementing, while a control signal of 011 will cause the counter to begin incrementing. The counter output is provided to a comparator 125 which compares its stored value of 0 with the data received from counter 120. When counter 120 reaches a count of 0, comparator 125 will record the correct comparison and provide an output signal on line 45. Counter 130 and its comparison circuit 135 operate in the same manner as counter 120 and its control circuit 125.

FIG. 5 illustrates an implementation of programmable logic 110 depicted in block diagram form in FIG. 2. As shown in FIG. 5, the programmable logic preferably consists of a series of six multiplexers 140, configured logically as two PLA circuits, one having four product term outputs and one having two product term outputs. Each of the two circuits receives four input signals. Each multiplexer has 16 input terminals, and each multiplexer receives a four-bit input signal from the external input c. The four-bit input signals selects a particular input from each multiplexer and supplies that as an output signal, one output signal being supplied from each mux 140 on a corresponding output line 143. The programmability is achieved by connecting each of the input terminals of each multiplexer to either ground or a potential source.

FIG. 6 illustrates the operation of the flags 100 shown in block form in FIG. 2. As shown in FIG. 6, four control bits select the operation of the flags 100. If all control bits are 0, then no action occurs. If only the least significant bit is a 1, then all flags are reset. If the next least significant bit is a 1, then all flags are set. The bottom four rows of FIG. 6 show the addressing of a specific flag and the setting or resetting of a specific flag based upon the least significant bit. For example, to address flag 2, the most significant bits will be 110, with the setting or resetting of the flag controlled by the fourth bit, as also shown in FIG. 6.

A general purpose state machine has been described which can be implemented as a portion of a larger integrated circuit. The state machine can be optimized for particular applications, for example, by reduction of area of the resulting integrated circuit, power consumption, or a combination of factors. The general purpose state machine can be implemented in software, firmware or hardware form.

The preceding has been a description of the preferred embodiment of a general purpose state machine. It will be appreciated that numerous modifications may be made from the described implementation, for example, by changing the implementation of the various components, expanding or contracting the buses, all without departing from the scope of the invention as defined by the appended claims.

What is claimed is:

1. A general purpose state machine comprising:
a first plurality of external input terminals for receiving information from an external circuit;
a first multiplexer having a plurality of input terminals, at least some of which are coupled to the external input terminals to receive the information therefrom, the first multiplexer supplying a first output signal;
a programmable memory storing a plurality of words, each word having a plurality of bits, a word from the memory being supplied in response to an address signal;
a control circuit connected to receive the output signal from the first multiplexer and connected to receive a first set of bits from a word in the programmable memory, the control circuit providing a signal selecting one of the words in the programmable memory; and
wherein the external circuit is connected to receive at least a second set of bits from the same word of the programmable memory as the first set of bits in response to selection of a word by the control circuit.

2. A general purpose state machine as in claim 1 further comprising a decoder coupled between the control circuit and the programmable memory, wherein the decoder is coupled to receive the signal from the control circuit, decode that signal, and thereby provide the address signal to select the word to be supplied by the programmable memory.

3. A general purpose state machine as in claim 2 further comprising a register connected between the decoder and the control circuit to temporarily store the signal from the control circuit selecting one of the words in the programmable memory.

4. A general purpose state machine as in claim 2 wherein the control circuit is coupled to also receive as an input signal, an address of a word previously selected.

5. A general purpose state machine as in claim 1 wherein the first set of bits received by the control circuit represents an address of a single word in the programmable memory.

6. A general purpose state machine as in claim 5 wherein the signal from the control circuit selects between the address provided by the first set of bits and the address of the word previously selected.

7. A general purpose state machine as in claim 5 wherein the first set of bits received by the control circuit represents addresses of two different words in the programmable memory.

8. A general purpose state machine as in claim 7 wherein:
the control circuit is coupled to also receive as an input signal, an address of a word previously selected; and
the control circuit selects among the two addresses represented by the first set of bits and the address of the previously selected word.

9. A general purpose state machine as in claim 1 wherein the input terminals of the first multiplexer are also connected to receive a third set of bits from the programmable memory.

10. A general purpose state machine as in claim 9 further comprising a second multiplexer having input terminals connected to each of the external input terminals, connected to the programmable memory to receive a fourth set of bits therefrom, and connected to provide an output signal to the control circuit.

11. A general purpose state machine as in claim 1 further comprising programmable logic coupled to at least some of the external input terminals and coupled to the first multiplexer to process information from the external circuit before it is provided to the first multiplexer.

12. A general purpose state machine as in claim 11 wherein the programmable logic comprises:
a first plurality of multiplexers connected in parallel to a plurality of external input terminals to provide a corresponding first plurality of output lines, each of the first plurality of multiplexers having a plurality of input terminals, each one of which is coupled to one of a first potential source and a second potential source; and
a second plurality of multiplexers also connected in parallel to the plurality of external input terminals to provide a corresponding second plurality of output lines, each of the second plurality of multiplexers having a plurality of input terminals, each one of which is coupled to one of the first potential source and the second potential source.

13. A general purpose state machine as in claim 1 further comprising at least one counter coupled to at least some of the external input terminals and coupled to the first multiplexer to process information from the external circuit before it is provided to the first multiplexer.

14. A general purpose state machine as in claim 1 further comprising at least one flag circuit coupled to at least some of the external input terminals and coupled to the first multiplexer to process information from the external circuit before it is provided to the first multiplexer.

15. A general purpose state machine as in claim 10 further comprising programmable logic coupled to at least some of the external input terminals and coupled to the second multiplexer to process information from the external circuit before it is provided to the second multiplexer.

16. A general purpose state machine as in claim 14 further comprising at least one counter coupled to at least some of the external input terminals and coupled to the second multiplexer to process information from the external circuit before it is provided to the second multiplexer.

17. A general purpose state machine as in claim 10 further comprising at least one flag circuit coupled to at least some of the external input terminals and coupled to the second multiplexer to process information from the external circuit before it is provided to the second multiplexer.

18. A general purpose state machine comprising:
a programmable memory storing a plurality of words, each word having a plurality of bits, a word from the memory being supplied in response to an address signal;
a control circuit coupled to receive at least first and second address signals from a word in the programmable memory, and coupled to receive signals from an external circuit, control circuit selecting one of the first address or the second address in response to the signals from the external circuit; and
wherein by selection of one of the address signals, the control circuit implements one of an unconditional branch operation or a two-way conditional branch operation.

19. A general purpose state machine as in claim 17 wherein:
the control circuit is also coupled to receive a third address signal representing a previously addressed word; and
by selection of one of the address signals, the control circuit implements one of an unconditional branch operation, a two-way conditional branch operation, a three-way conditional branch operation, or a wait until conditional branch operation.
